(19) United States
(12) Patent Application Publication
(10) Pub. No.: US 2012/0174596 A1
(43) Pub. Date: Jul. 12, 2012

(54) SYSTEMS AND METHODS FOR IMPROVED COMBUSTION OPERATIONS

(75) Inventor: Richard HUNTINGTON, Oak Hill, VA (US)

(73) Assignee: EXXONMOBIL RESEARCH AND ENGINEERING COMPANY, Annandale, NJ (US)

(21) Appl. No.: 13/005,098

(22) Filed: Jan. 12, 2011

(51) Int. Cl. F02C 3/20

(52) U.S. Cl. 60/780; 60/39.12

(57) ABSTRACT

Systems and methods for improving the operation of a combustion device using a low heating value fuel that includes providing a supply of a low heating value fuel, introducing an oxidizing agent that includes an enriched oxygen source into the low heating value fuel, and directing the low heating value fuel and the oxidizing agent to the combustion device, whereby the operation of the combustion device is improved.

### FIELD

The presently disclosed subject matter relates to methods and systems to improve combustion operations, such as the operation of gas turbines. This improved combustion operation is particularly applicable to chemical processing and petrochemical refining operations.

### BACKGROUND

Combustion devices (e.g., gas combustion turbines) in manufacturing applications, such as chemical processing and petrochemical refining operations, provide a source for energy and work. For example, such combustion devices can generate electricity to supplement plant operations and reduce the consumption of electricity from external electricity providers. Additionally, combustion devices can be employed to drive equipment or the like. Such devices generally employ a hydrocarbon fuel source.

Combustion devices can theoretically operate with a wide range of fuels from light gases to heavy liquids. Practical limitations exist that limit use of fuel gases generally considered low heating value (LHV) fuels. For example, one difficulty caused by low heating value fuels relates to the lower adiabatic flame temperatures that result from their combustion in the combustion device. Each combustion device can be considered to have a range of blow off limits that can be characterized using the ratio of the chemical reaction time of the fuel and oxidizer being consumed in the flame versus the flow time characteristic of the combustor system. For a given combustor system, the flow time is relatively steady. Thus, if different fuels and/or oxidizers are introduced to the combustion system, the changes to the blow off limits are generally only affected by the changes to the chemical reaction times with the differing fuel and/or oxidizer. As the flame temperature is reduced with the introduction of lower heating value fuels, the chemical reaction is slowed (i.e., greater chemical time) and the blow off event occurs at a greater flow time. In other words, the blow off occurs at a lower velocity within the combustor system and hence the blow off is more probable at standard combustion operating conditions. Combustion stability, and in particular, lean blowout of the flame therefore limit the use of LHV fuels in conventional combustion devices. Even when it is possible to burn LHV fuels, the operation at part load, known as turndown, can be limited to the point that the combustion device is not reliably operable.

Chemical processing and petrochemical refining operations typically provide hydrocarbon fuel sources, often as by-products or even waste products of unrelated unit operations within the plant, that could be used to power combustion devices. These hydrocarbon fuel sources, however, may be low heating value gases. As discussed above, the use of low heating value gases in combustion devices (e.g., combustion turbines) creates an elevated risk of lean blowout or blow off of the flame within the combustor.

There remains a need to better utilize all available fuel sources, particularly at a refinery, to maximize internal work generation (e.g., electricity generation), and to minimize consumption of electricity from third-party providers. This can be provided by methods to improve the operation of combustion turbines and other combustion devices that consume low heating value fuels.

### SUMMARY

One aspect of the present application provides a method of improving the operation of a combustion device using a low heating value fuel. The method includes providing a supply of the low heating value fuel, introducing an oxidizing agent having an enriched oxygen source into the low heating value fuel, and directing the low heating value fuel and the oxidizing agent to a combustion device in a chemical processing or petrochemical refining operation for combustion thereof.

In one embodiment, the low heating value fuel (e.g., a low BTU fuel) is obtained from a thermal cracking petrochemical refining operation, such as a thermal cracking petrochemical refining operation that converts heavy crude oil fractions from a distillation process into lighter, gasoline and distillate boiling-range components. An example of such a thermal cracking petrochemical refining operation is a Flexicoking™ process. Accordingly, the low heating value fuel can be obtained from Flexicoker™ operation products, such as low BTU fuels obtained as a product from Flexicoking™ operations that contain, for example, N₂, CO, H₂ and CO₂ as principle constituents. In a further embodiment, a compressor can be provided to provide compressed air to an oxygen enrichment device and/or a Flexicoking™ unit for use as supplemental air.

In an alternative embodiment, the low heating value fuel includes a waste gas stream from a petrochemical refining operation. The petrochemical refining operation can be, for example, a distillation operation, a separate combustion operation (e.g., processes involving a furnace), a scrubbing operation, and/or a reaction operation (e.g., a MTO or MTG operation).

In one embodiment, the oxidizing agent includes air enriched with oxygen. The oxygen-enriched air can be supplied to a combustion device via an intake manifold that is provided on the combustion device. The oxidizing agent can be obtained from a separate unit operation within a petrochemical refining operation, or other manufacturing operation. For example, the oxidizing agent (e.g., oxygen-enriched air) can be obtained from a nitrogen purification process (e.g., from a waste stream of a nitrogen purification process). In alternative embodiments, the oxidizing agent can be obtained from pressure swing absorption processes, temperature swing absorption processes, membrane separation processes and/or refrigerated air separation processes. In one embodiment, the oxidizing agent (e.g. oxygen enriched air) has not undergone, or does not require, processing (e.g., membrane separation) to obtain increased oxygen purity. For example, the oxidizing agent can be obtained and used “as-is” from a parallel, already existing process (e.g. a parallel, already existing process within a petrochemical refining operation) such as, but not limited to the processes described above (e.g., from a nitrogen purification process, a pressure swing absorption process, a temperature swing absorption process, a membrane separation process and/or a refrigerated air separation process).

Embodiments of the present application also provide a system for producing work or electricity. The system includes a supply of a low heating value fuel, a supply of an oxidizing agent having an enriched oxygen source; and a combustion device of a chemical processing or petrochemical refining operation to receive at least a portion of the supply of the low heating value fuel and at least a portion of the supply of oxidizing agent.

The low heating value fuel can be obtained from a thermal cracking petrochemical refining operation, such as a thermal cracking petrochemical refining operation that converts heavy crude oil fractions from a distillation process into lighter, gasoline and distillate boiling-range components. An example of such a thermal cracking petrochemical refining operation is a Flexicoking™ process.

By applying methods and implementing systems according to embodiments of the present application, the adiabatic flame temperature of the combustion device is increased, and the margin to lean blowout or blow off of the flame is also increased. The operating reliability of the combustion device is improved due to the increased the operating range.

### BRIEF DESCRIPTION OF THE DRAWINGS

FIG. 1 is a schematic depiction of a combustion system that employs oxygen-enriched air at low or ambient pressure using Flexicoking™ unit offgas as a low heating value fuel.

FIG. 2 is a schematic depiction of a combustion system that employs oxygen-enriched air at medium pressure using Flexicoking™ unit offgas as a low heating value fuel.

FIG. 3 is a schematic depiction of a combustion system that employs oxygen-enriched air at high pressure using Flexicoking™ unit offgas as a low heating value fuel.

FIG. 4 is a schematic depiction of a combustion system that employs oxygen-enriched air using Flexicoking™ unit offgas as a low heating value fuel, in which Flexicoking process receives a supply of compressed air for use as supplemental air.

FIG. 5 is a schematic depiction of a combustion system that employs oxygen-enriched air using Flexicoking™ unit offgas as a low heating value fuel, in which an oxygen enrichment device is provided with a supply of compressed air.

FIG. 6 is a schematic depiction of a combustion system that employs oxygen-enriched air using Flexicoking™ unit offgas as a low heating value fuel, in which an oxygen enrichment device and the Flexicoking™ unit is provided with a supply of compressed air.

### DETAILED DESCRIPTION

As used herein, the term “GHSV” refers to term “gaseous hourly space velocity” and is the ratio of the gaseous volumetric flow rate, at standard conditions of 60° F. and one atmosphere of pressure, to the reactor volume.

As used herein the term “a waste gas stream,” refers to a gas stream from a unit operation that is not associated with the primary end-product of the unit operation, but is instead produced as a by-product, or an otherwise-undesired waste product. According to one embodiment of the presently disclosed subject matter, a waste gas stream can be used as a low heating value fuel for the combustion device.

Air is a mixture of gases that contains, as principal components, for example, nitrogen (75.47 wt %), oxygen (23.20 wt %), argon (1.28 wt %), and carbon dioxide (0.05 wt %). The weight percentages presented herein are exemplary and not limitations. As used herein, the term “air enriched with oxygen” or oxygen-enriched air” refers to a gas that generally comprises the same components as air, but in which the amount of oxygen exceeds 23.20% by weight. In one embodiment, the amount of oxygen exceeds about 25%, or about 28%, or about 30%, or about 35%, or about 40% by weight, based on the total composition of the oxygen-enriched air.

As used herein, the term “provided in an industrial scale” refers to a scheme in which, for example, gasoline or other product of commercial interest is produced on a continuous basis (with the exception of necessary outages for plant maintenance or upgrades) over an extended period of time (e.g., over at least a week, or a month, or a year) with the expectation of generating revenues from the sale or distribution of the product of commercial interest. Production in an industrial scale is distinguished from laboratory or pilot plant settings which are typically maintained only for the limited period of the experiment or investigation, and are conducted for research purposes and not with the expectation of generating revenue from the sale or distribution of the end product produced thereby.

In one embodiment, the low heating value is obtained from manufacturing operation that is provided in an industrial scale. For example, the low heating value fuel can be obtained from a waste gas stream of a manufacturing operation that is provided at an industrial scale.

As used herein, the term “low heating value fuel” or “LHV fuel” refers to a flammable fuel, preferably a hydrocarbon, that, when fed to a combustion device under safe, and standard operating conditions, does not provide a safe or reliable operating range. A person of ordinary skill in the art can identify a low heating value fuel based on the heating value for the fuel (energy per unit mass), in view of the process and combustion systems for which it is employed. In one embodiment, a flammable fuel having a heating value in the range of from about 2 MJ/kg to about 50 or 75 MJ/kg, or from about 10 MJ/kg to about 60 MJ/kg, or from about 12 MJ/kg to about 50 MJ/kg, or from about 15 MJ/kg to about 50 MJ/kg, or from about 12 MJ/kg to about 30 or 40 MJ/kg, or from about 12 MJ/kg to about 30 MJ/kg is employed as the low heating value fuel. In one embodiment, the low heating value fuel has a heating value of from about 3 MJ/kg to about 7 MJ/kg, or from about 3.5 MJ/kg to about 5.5 MJ/kg.

Reference will now be made to various aspects of the present application in view of the definitions above. The system and corresponding components of the system will be described in conjunction with the detailed description of the method.

One aspect of the present application provides a method of improving the operation of a combustion device using a low heating value fuel. The method includes providing a supply of the low heating value fuel, introducing an oxidizing agent having an enriched oxygen source into the low heating value fuel, and directing the low heating value fuel and the oxidizing agent to a combustion device in a chemical processing or petrochemical refining operation for combustion thereof.

An alternative aspect includes a system for producing work or electricity. The system includes a supply of a low heating value fuel, a supply of an oxidizing agent having an enriched oxygen source; and a combustion device of a chemical processing or petrochemical refining operation to receive at least a portion of the supply of the low heating value fuel and at least a portion of the supply of oxidizing agent. The system will be understood and described in greater detail from the description of the methods disclosed herein.

The low heating value fuel for use in the present application can be obtain from, for example, a thermal cracking operation, such as Flexicoking, an air-blown partial oxidation process or biomass conversion process.

In one embodiment, the low heating value fuel is obtained from a thermal cracking petrochemical refining operation, such as a thermal cracking petrochemical refining operation that converts heavy crude oil ground fractions from a distillation process into lighter, gasoline and distillate boiling-range components. An example of such a thermal cracking petrochemical refining operation is a Flexicoking™ process. Accordingly, the low heating value fuel can be obtained from Flexicoker™ operation products. In a preferred embodiment, the thermal cracking operation from which the low heating value fuel is obtained is a fluidized bed unit operation that convert heavy oils into lighter-boiling gasoline, diesel and distillate boiling range components (e.g., a Flexicoking™ Conversion Process). Such conversion can be achieved, for example, by feeding one or more heavy oils (e.g., Kuwait 1050° F.+Vac. resid) to a reactor/scrubber/fractionater to obtain reactor gas, coker naptha, light coker gas oil, heavy coker gas oil. Gross coke bottoms from the reactor/scrubber/fractionator can be fed to a heater/gasifier to obtain a gas stream (referred to as “Flexigas,” which is an alternative to fuel gas), and net coke bottoms. In a preferred embodiment, the “Flexigas” is employed as a low value heating fuel for use in the systems and processes described herein.

Examples of heavy oils include, but are not limited to, vacuum resid, atmospheric resid, oil sands bitumen, heavy whole crudes, deasphalter bottoms, or FCC bottoms. Such heavy oils can be converted to low heating value fuel sources that can be used, alone or in combination, to fuel a combustion device (e.g., a combustion turbine fitted with an air-intake manifold that is supplied with a source of air-enriched with oxygen).

An example of a preferred process from which low heating value fuel can be obtained is the Flexicoking™ Conversion Process, in which the production of petroleum coke is minimized and/or essentially eliminated, while obtaining lower-boiling range components that can be used as fuel sources. Flexicoking™ integrates fluid bed coking and air gasification to eliminate petroleum coke production. It allows refiners to process vacuum resid, atmospheric resid, oil sands bitumen, heavy whole crudes, deasphalter bottoms, or thermal cracked tar to produce higher-value liquid and gas products. Flexicoking™ produces clean low-sulfur fuel gas which can be used economically in refinery furnaces and boilers, as well as by nearby consumers such as power plants, to reduce NOx and SOx emissions. Further information about the Flexicoking™ process can be obtained from ExxonMobil Research and Engineering Co. (Fairfax, Va.).

In an alternative embodiment, the low heating value fuel includes a waste gas stream from a petrochemical refining operation. The petrochemical refining operation can be, for example, a distillation operation, a separate combustion operation (e.g., processes involving a furnace), a scrubbing operation, and/or a reaction operation (e.g., a MTO or MTG operation). Additional sources of low heating value fuels likewise are available and can be used.

Oxidizing agents having an enriched oxygen source are available in a variety of suitable forms and sources. For example, but not limitation, the oxidizing agent can include air enriched with oxygen. Oxygen-enriched air can be obtained from sources known in the art. For example, air can be supplemented from oxygen that has been obtained from a Pressure Swing Absorption (PSA) process that extracts oxygen from atmospheric air. Alternatively, the oxidizing agent can be obtained from a separate unit operation within a petrochemical refining operation, or other manufacturing operation. For example, the oxidizing agent (e.g., oxygen-enriched air) can be obtained from a nitrogen purification process (e.g., from a waste stream of a nitrogen purification process).

Alternatively, oxygen can be obtained from an oxygen generator. Oxygen generators are commercially available from, for example, Oxygen Enrichment Systems (Niagara Falls, N.Y.), Linde, LLC (Murray Hill, N.J.), and Avalence LLC (Milford, Conn.).

As embodied herein, reduced chemical time of low heating value (LHV) fuels within a combustion system is overcome by increasing the oxygen content of the “air” available for combustion. In a conventional gas turbine engine, ambient air is used to supply the oxidizing agent for combustion. For purposes of illustration, and not limitation, the oxygen content is fixed at about 21% oxygen, 78% nitrogen and 1% argon and other trace components. In the flame, the nitrogen and argon from the air are essentially inert in the combustion process and their presence reduces the adiabatic flame temperature in the same manner as the LHV fuels. By increasing the oxygen content of the “air”, the lower levels of inerts entering the combustor with the “air” balance the effects of a LHV fuel by increasing the adiabatic flame temperature. The increased adiabatic flame temperature results in an increased margin to blow off within the combustor and increased operating range of the combustion device and/or the acceptable range of fuel heating value.

Extra oxygen can be added to the air stream (the oxidizing agent) in different methods and locations. Extra oxygen can be added at the main ambient air inlet to the combustion device or elsewhere at the inlet to the compressor section of the combustion device. Extra oxygen can also be introduced at an intermediate pressure level within the air compressor or piping associated with the air compressor. Extra oxygen can also be introduced at, or after, the final compressor discharge within the compressor or piping associated with the compressor or gas turbine engine. Or extra oxygen can be introduced at or near the combustor assembly. The location of introduction of extra oxygen can depend on the available pressure level. In one embodiment, oxygen is added at an air compressor inlet to utilize the existing gas turbine compression equipment and by doing so, to displace a portion of the ambient air that would normally enter the compressor.

The extra oxygen can be added in the form of high purity oxygen or oxygen diluted with other gases, such as (but not limited to) nitrogen and argon. In one embodiment, oxygen-enriched air is added that is much higher in oxygen content than ambient air but that does not required specialized processing to attain high oxygen purity or that can be an unwanted byproduct of the production of high purity nitrogen. The oxygen-enriched air can be supplied to a combustion device via an intake manifold that is provided on the combustion device.

According to one embodiment, the amount of extra oxygen added to the combustion device can be modulated to control the performance of the combustion system according to changes to the heating value of the fuel, while operating at part load conditions and/or with changes in ambient conditions. For example, the heating value of the fuel can be monitored, and extra oxygen can be added when the heating value is below pre-determined, set limits. The oxygen-enriched air can be supplied to a combustion device via an intake manifold that is provided on the combustion device. The amount of extra oxygen can be modulated based upon on the sensed heating value of the fuel and/or the sensed load on the combustion device (e.g., the turbine). The amount can be increased for decreases in the heating value of the fuel or load on the combustion device. A controller can be provided to modulate the supply based upon the sensed values.

Operating conditions for the combustion devices that are employed in the methods and systems of the presently disclosed subject matter can be determined by persons of ordinary skill in the art. For example, operating details for combustion devices can be found, for example, in U.S. Pat. Nos. 5,927,063, 4,285,193, 2,938,871, and 2,712,728 and U.S. Published Patent Application No. 2008/0305445. Each of these patents and patent applications are hereby incorporated by reference in their entirety.

The Figures further illustrate non-limiting, exemplary systems and processes which can be used in accordance with the presently disclosed subject matter.

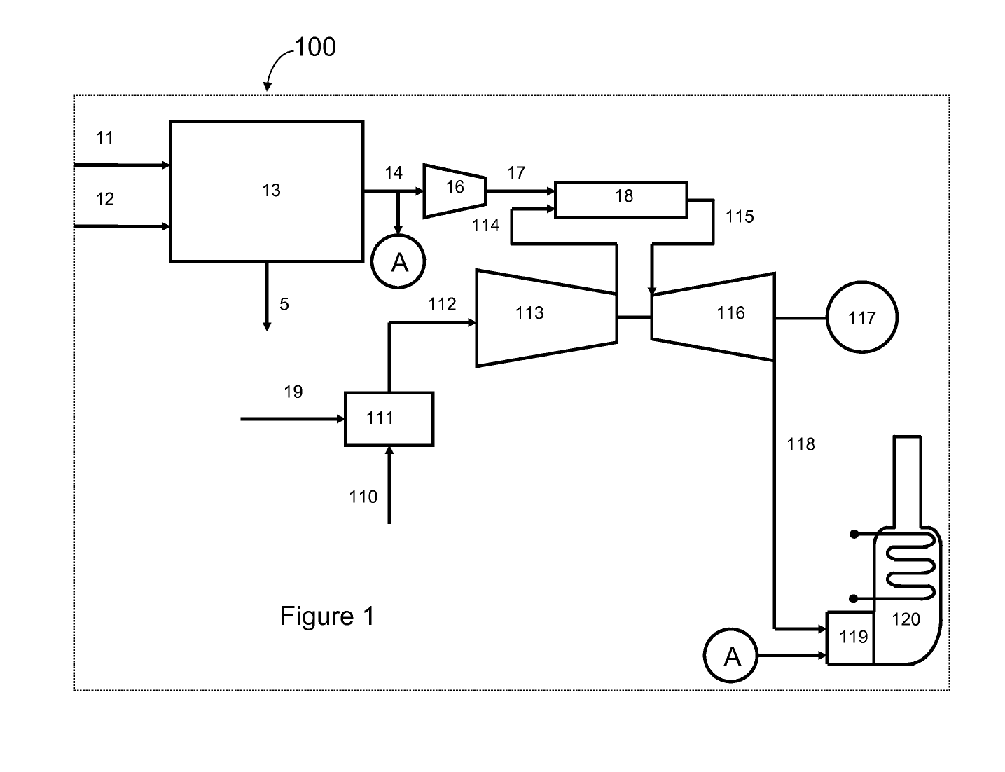

With reference to FIG. 1, a system (100) for providing oxygen-enriched air at low or ambient pressure is disclosed according to a non-limiting embodiment. A supply of ambient air (11) is provided along with a heavy hydrocarbon feed (12), and directed to a Flexicoking™ unit (13) or similar thermal cracking process. The Flexicoking™ unit yields liquid hydrocarbon products (15) and offgas (14) (sometimes referred to as “Flexigas”). A portion (A) of the offgas stream (14) can be directed to an optional duct burner (119) which powers on optional heat recovery steam generator or fired heater (120), discussed below. The remaining offgas supply is directed to a compressor (16) and the compressed gas (17) is fed to a gas turbine combustor (18).

A second feed of ambient air (19), along with oxygen enriched air (110) is also provided to eventually yield a high pressure oxidant stream (114) which is also directed to the gas turbine combustor (18). To provide the high pressure oxidant stream ambient air (19) and oxygen enriched air (110) is directed to a plenum (111). Alternatively ducting or a GT compressor inlet could be provided instead of the plenum. An oxidant stream (112) that includes a mixture of ambient air and oxygen enriched air is directed to a gas turbine compressor section (113), the output of which (114) being directed to the gas turbine combustor (18).

High pressure products of combustion (115) from the gas turbine combustor (18) is directed to a gas turbine expander section (116), which can in turn be used in a generator (117) or other load. The gas turbine exhaust stream (118) along with a portion of the offgas (14) from the Flexicoking™ unit (13) can directed to an optional duct burner (119), which can feed a heat recovery steam generator or fired heater (120).

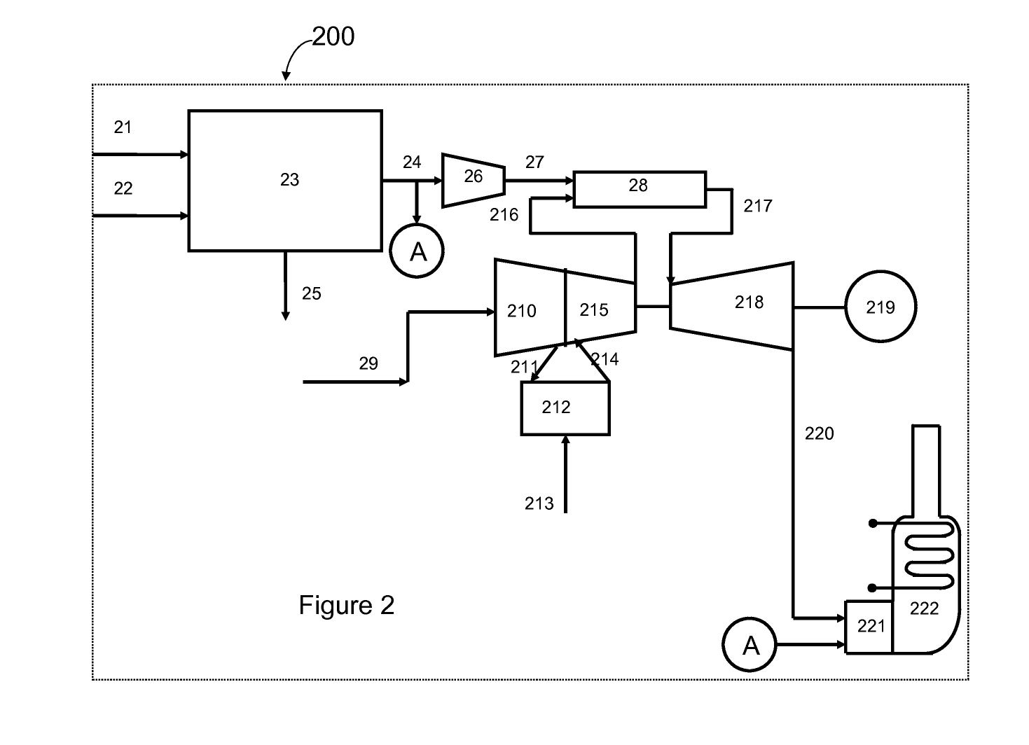

With reference to FIG. 2, a system (200) for providing oxygen-enriched air at medium pressure is disclosed according to a non-limiting embodiment. A supply of ambient air (21) is provided along with a heavy hydrocarbon feed (22), and directed to a Flexicoking™ unit (23) or similar thermal cracking process. The Flexicoking™ unit yields liquid hydrocarbon products (25) and offgas (24) (sometimes referred to as “Flexigas”). A portion (A) of the offgas stream can be directed to an optional duct burner (221) which powers on optional heat recovery steam generator or fired heater (222). The remaining offgas supply is directed to a compressor (26) and the compressed gas (27) is fed to a gas turbine combustor (28).

A second feed of ambient air (29) is directed to a first gas turbine compressor section (210). Output (211) from the first gas turbine compressor section (210) is directed to a mixing drum (212) or portion of compressor casing. The mixing drum (212) also received a feed of medium pressure oxygen enriched air (213), and the mixed composition exiting the mixing drum (214) is fed to a second turbine compressor section (215). The high pressure oxidant (216) leaving the second turbine compressor section (215) is introduced to the gas turbine combustor (28) along with the compressed gas (27) to yield high pressure products of combustion (217).

The high pressure products of combustion (217) is introduced to a gas turbine expander section (218), which can be used to power a generator (219) or other load. The gas turbine exhaust stream (220) along with a portion of the offgas (24) from the Flexicoking™ unit (23) can directed to an optional duct burner (221), which can feed a heat recovery steam generator or fired heater (222).

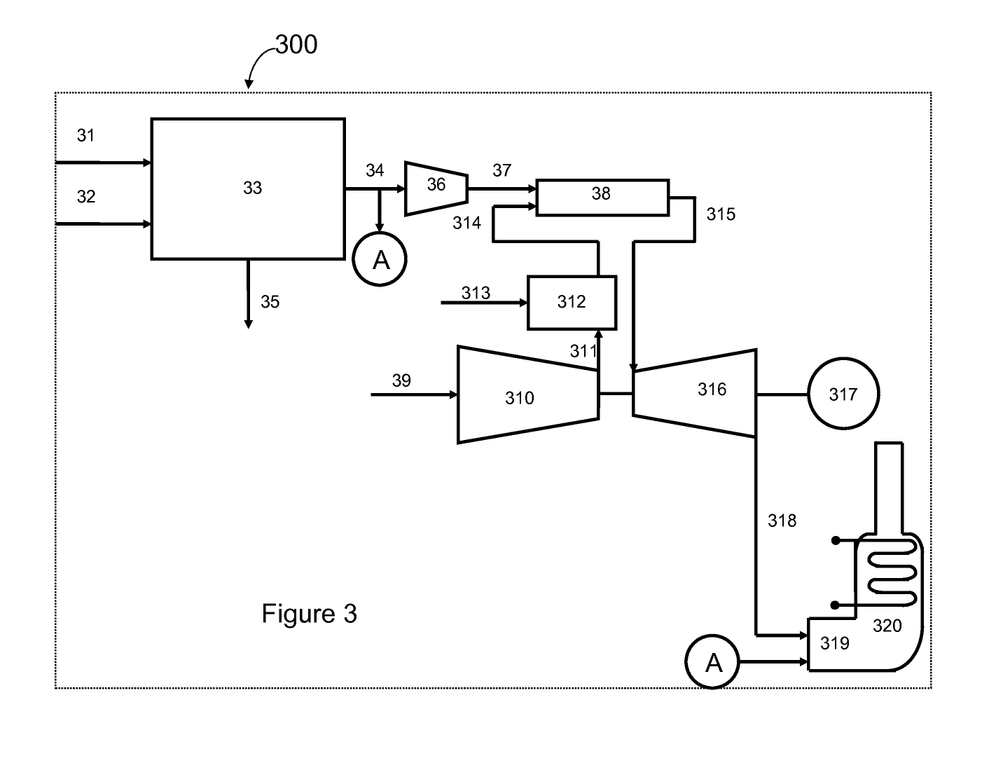

With reference to FIG. 3, a system (300) for providing oxygen-enriched air at high pressure is disclosed according to a non-limiting embodiment. A supply of ambient air (31) is provided along with a heavy hydrocarbon feed (32), and directed to a Flexicoking™ unit (33) or similar thermal cracking process. The Flexicoking™ unit yields liquid hydrocarbon products (35) and offgas (34) (sometimes referred to as “Flexigas”). A portion (A) of the offgas stream can be directed to an optional duct burner (319) which powers on optional heat recovery steam generator or fired heater (320). The remaining offgas supply is directed to a compressor (36) and the compressed gas (37) is fed to a gas turbine combustor (38).

A second feed of ambient air (39) is directed to a gas turbine compressor section (310), the compressed ambient air (311) being introduced to a mixing drum (312). Alternatively, the ambient air can be introduced to a volume within the gas turbine casing or combustor assembly. The mixing drum (311) also receives a feed of high pressure oxygen enriched air (313) and yields a supply of high pressure oxidant (314), which is fed to the gas turbine combustor (38) along with the compressed gas (37) to yield high pressure products of combustion (315). The high pressure products of combustion (315) is introduced to a gas turbine expander section (316) which can power a generator (317) or other load. The gas turbine exhaust stream (318) (along with a portion of the offgas (34) from the Flexicoking™ unit) can be introduced to a optional duct burner (319) to feed a heat recovery steam generator (320) or fired heater.

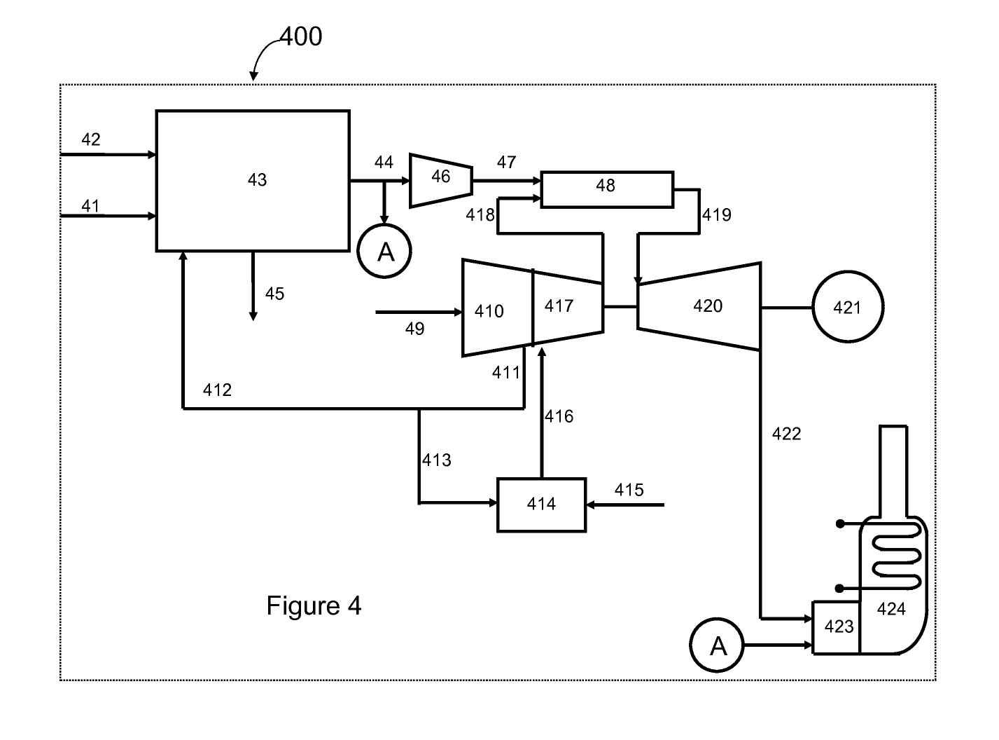

With reference to FIG. 4, a system (400) that integrates a gas turbine with a Flexicoking™ unit, or other thermal cracking process, according to a non-limiting embodiment. A feed of ambient air (41) and a heavy hydrocarbon feed (42) are introduced a Flexicoking™ unit (43), or other thermal cracking process to yield Flexicoking™ unit liquid hydrocarbon products (45) and Flexicoking™ unit offgas (44) (sometimes referred to as “Flexigas”). At least a portion (A) of the offgas (44) is directed to a Flexigas compressor (46) to yield high pressure Flexigas (47), which is directed to a gas turbine combustor (48).

A second stream of ambient air (49) is fed to a first gas turbine compressor section (410). A stream of compressed ambient air (411) is withdrawn from the first compressor section and, a portion of which (412) is introduced to the Flexicoking unit to provide supplemental air. A second portion of the compressed ambient air (413) is directed to a mixing drum (414) or portion of a compressor casing. The mixing drum also receives a feed of medium pressure oxygen-enriched air (415), which yields a medium pressure oxidant stream (418) that is fed to a second turbine compressor section (417). High pressure oxidant (418) output from the second compressor section is introduced, along with the high pressure Flexigas (47), to a gas turbine combustor (48). The gas turbine combustor yields high pressure products of combustion (419), that is introduced to a gas turbine expander section (420), which can be used to power a generator (421) or other load. The gas turbine exhaust stream (422) can be introduced, along with a portion of offgas (44) to a duct burner (423) to feed a heat recovery steam generator (424) or fired heater.

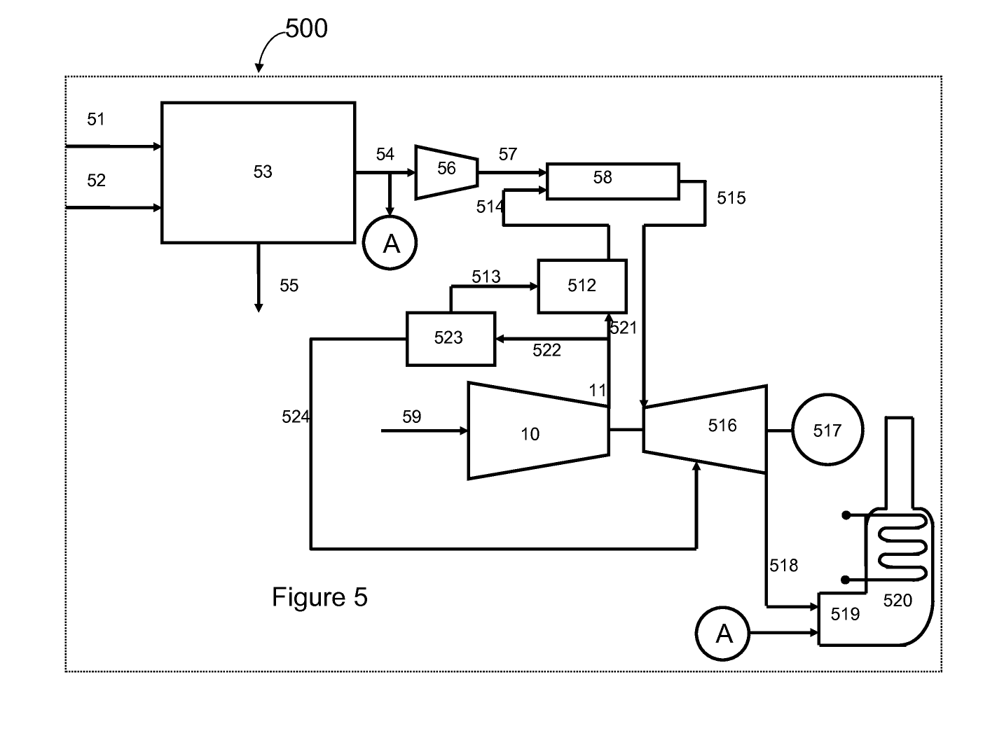

With reference to FIG. 5, a system (500) that employs high pressure air extracted from a gas turbine as a feed for an oxygen enrichment device is provided, according to a non-limiting embodiment. A feed of ambient air (51) and a heavy hydrocarbon feed (52) are introduced a Flexicoking™ unit (53), or other thermal cracking process to yield Flexicoking™ unit liquid hydrocarbon products (55) and Flexicoking™ unit offgas (54) (sometimes referred to as “Flexigas”). At least a portion (A) of the offgas (54) is directed to a Flexigas compressor (56) to yield high pressure Flexigas (57), which is directed to a gas turbine combustor (58).

A second stream of ambient air (59) is directed to a gas turbine compressor section (510) to yield high pressure compressed ambient air (511). A portion (522) of the high pressure compressed ambient air (511) is directed to an oxygen enrichment device (523) such as a pressure swing adsorption process, or membrane to provide high pressure oxygen-enriched air (513) and oxygen-depleted air (524). The oxygen-depleted air (524) from the oxygen enrichment device is introduced to a gas turbine expander section (516), discussed below. The high pressure oxygen-enriched air (513) from the oxygen enrichment device, along with a portion (521) of the high pressure compressed air is introduced to a mixing drum (512) or volume within the gas turbine casing or combustion assembly to yield a high pressure oxidant (514) that is fed to a gas turbine combustor along with the offgas (54) from the Flexicoking™ unit.

High pressure products of combustion (515) leaving the gas turbine combustor (58), along with a feed of oxygen-depleted air (524) from the oxygen enrichment device, is introduced to a gas turbine expander section (516), which can be used to power a generator (517) or other load. The gas turbine exhaust stream (518), along with a portion of the offgas (54) from the Flexicoking™ unit can be introduced to duct burner (519) to feed a heat recovery steam generator (520) or fired heater.

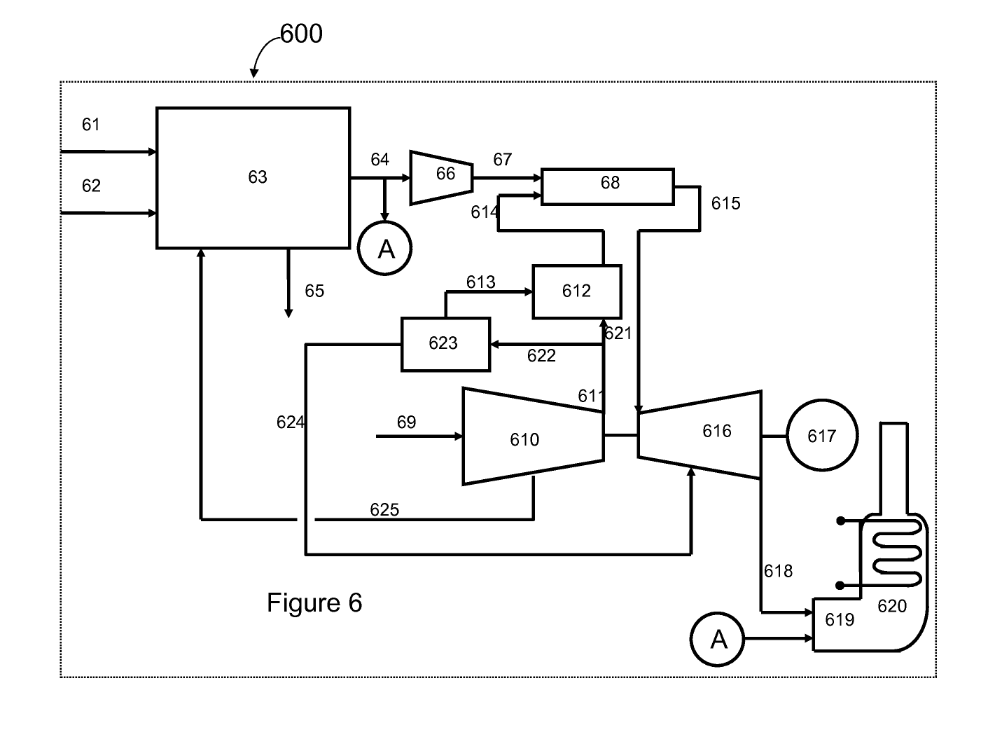

With reference to FIG. 6, a system (600) that integrates a gas turbine combustion device with a Flexicoking™ unit and employs high pressure air extracted from a gas turbine as a feed for an oxygen enrichment device is provided, according to a non-limiting embodiment. A feed of ambient air (61) and a heavy hydrocarbon feed (62) are introduced a Flexicoking™ unit (63), or other thermal cracking process to yield Flexicoking™ unit liquid hydrocarbon products (65) and Flexicoking™ unit offgas (64) (sometimes referred to as “Flexigas”). At least a portion of the offgas (64) is directed to a Flexigas compressor (66) to yield high pressure Flexigas (67), which is directed to a gas turbine combustor (68).

A second stream of ambient air (69) is directed to a gas turbine compressor section (610) to yield a first portion of high pressure compressed ambient air (611). A second portion (625) of compressed ambient air is directed to a Flexicoking™ unit for use as supplemental air. A portion (622) of the high pressure compressed ambient air (611) is directed to an oxygen enrichment device (623) such as a pressure swing adsorption process, or membrane to provide high pressure oxygen-enriched air (613) and oxygen-depleted air (624). The oxygen-depleted air (624) from the oxygen enrichment device is introduced to a gas turbine expander section (616), discussed below. The high pressure oxygen-enriched air (613) from the oxygen enrichment device, along with a portion (621) of the high pressure compressed air is introduced to a mixing drum (612) or volume within the gas turbine casing or combustion assembly to yield a high pressure oxidant (614) that is fed to a gas turbine combustor along with the offgas (64) from the Flexicoking™ unit.

High pressure products of combustion (615) leaving the gas turbine combustor (68), along with a feed of oxygen-depleted air (624) from the oxygen enrichment device, is introduced to a gas turbine expander section (616), which can be used to power a generator (617) or other load. The gas turbine exhaust stream (618), along with a portion of the offgas (64) from the Flexicoking™ unit can be introduced to duct burner (619) to feed a heat recovery steam generator (620) or fired heater.

The presently disclosed subject matter is not to be limited in scope by the specific embodiments described herein. Indeed, various modifications of the invention in addition to those described herein will become apparent to those skilled in the art from the foregoing description and the accompanying figures. Such modifications are intended to fall within the scope of the appended claims.

It is further to be understood that all values are approximate, and are provided for description.

Patents, patent applications, publications, product descriptions, and protocols are cited throughout this application, the disclosures of each of which is incorporated herein by reference in its entirety for all purposes.

1. A method of improving operation of a gas turbine combustion device using a low heating value fuel comprising:
(a) providing a supply of low heating value fuel;
(b) introducing an oxidizing agent having an enriched oxygen source into the low heating value fuel; and
(c) directing the low heating value fuel and the oxidizing agent to a combustion device in a chemical processing or petrochemical refining operation for combustion thereof.

2. The method of claim 1, wherein the low heating value fuel is obtained from a thermal cracking petrochemical refining operation.

3. The method of claim 1, wherein the thermal cracking petrochemical refining operation is a Flexicoking operation that converts heavy crude oil ground fractions from a distillation process into lighter, gasoline and distillate boiling-range components and a gas byproduct stream.

4. The method of claim 3, wherein the supply of low heating value fuel is obtained from the gas byproduct stream.

5. The method of claim 1, wherein the low heating value fuel includes a waste gas stream from a petrochemical refining operation.

6. The method of claim 2, wherein the oxidizing agent includes air enriched with oxygen.

7. The method of claim 6, further including providing an intake manifold on the combustion device and introducing the air enriched with oxygen into the low heating value fuel through the intake manifold.

8. The method of claim 1, wherein the air enriched with oxygen is obtained from a nitrogen purification process.

9. The method of claim 6, wherein oxygen is introduced to air at an air inlet to the combustion device, at an inlet to a compressor section of the combustion device, within a compressor section of the combustion device, at or after a final compressor discharge, or at or near the combustor assembly.

10. The method according to claim 1, wherein introducing an oxidizing agent having an enriched oxygen source into the low heating value fuel includes modulating the introduction of the oxidizing oxygen.

11. The method according to claim 10, wherein the modulation is based upon at least one of the heating value of the fuel and the load on the turbine.

12. A system for producing work or electricity comprising:
(a) a supply of a low heating value fuel;
(b) a supply of an oxidizing agent having an enriched oxygen source; and
(c) a combustion device of a chemical processing or petrochemical refining operation to receive at least a portion of the supply of the low heating value fuel and at least a portion of the supply of oxidizing agent.

13. The system of claim 12, wherein the supply of low heating value fuel is from a thermal cracking petrochemical refining operation.

14. The system of claim 13, wherein the thermal cracking petrochemical refining operation converts heavy crude oil ground fractions from a distillation process into lighter, gasoline and distillate boiling-range components.

15. The system of claim 12, wherein the supply of low heating value fuel includes a waste gas stream from a petrochemical refining operation.

16. The system of claim 12, wherein the oxidizing agent includes air enriched with oxygen.

17. The system of claim 16, wherein the combustion device includes an intake manifold to receive the air enriched with oxygen.

18. The system of claim 12, wherein the air enriched with oxygen is from a nitrogen purification process.

19. The system according to claim 12, wherein the supply of the oxidizing agent is modulated.

20. A method of improving operation of a gas turbine combustion device using a low heating value fuel obtained from a Flexicoking thermal cracking process comprising:
(a) providing a supply of a low heating value fuel from a Flexicoking thermal cracking process;
(b) introducing an oxidizing agent having an enriched oxygen source into the low heating value fuel from the Flexicoking thermal cracking process; and
(c) directing the low heating value fuel from the Flexicoking thermal cracking process and the oxidizing agent to a combustion device in a chemical processing or petrochemical refining operation for combustion thereof.

21. The method of claim 20, further comprising providing a source of compressed ambient air for introduction to the Flexicoking thermal cracking process to provide supplemental air.

22. The method according to claim 20, wherein introducing an oxidizing agent having an enriched oxygen source into the low heating value fuel includes modulating the introduction of the oxidizing oxygen.

23. The method according to claim 22, wherein the modulation is based upon at least one of the heating value of the fuel and the load on the turbine.

24. A method of improving operation of a gas turbine combustion device using a low heating value fuel comprising:
(a) providing a supply of low heating value fuel;
(b) introducing an oxidizing agent having an enriched oxygen source into the low heating value fuel; and
(c) directing the low heating value fuel and the oxidizing agent to a combustion device in a chemical processing or petrochemical refining operation for combustion thereof,
wherein the oxidizing agent is obtained from an oxygen enrichment device that receives a feed of compressed ambient air from a compressor.

25. The method of claim 24, wherein the thermal cracking petrochemical refining operation is a Flexicoking operation that converts heavy crude oil ground fractions from a distillation process into lighter, gasoline and distillate boiling-range components and a gas byproduct stream.

26. The method of claim 25, wherein the supply of low heating value fuel is obtained from the gas byproduct stream.

27. The method of claim 24, wherein the oxygen enrichment device is selected from (a) a pressure swing oxygen adsorber and (b) a membrane sized to provide an oxygen-enriched air stream.

28. The method according to claim 24, wherein introducing an oxidizing agent having an enriched oxygen source into the low heating value fuel includes modulating the introduction of the oxidizing oxygen.

29. The method according to claim 28, wherein the modulation is based upon at least one of the heating value of the fuel and the load on the turbine.

30. A method of improving operation of a gas turbine combustion device using a low heating value fuel obtained from a Flexicoking thermal cracking process comprising:
(a) providing a supply of a low heating value fuel from a Flexicoking thermal cracking process;
(b) introducing an oxidizing agent having an enriched oxygen source into the low heating value fuel from the Flexicoking thermal cracking process; and
(c) directing the low heating value fuel from the Flexicoking thermal cracking process and the oxidizing agent to a combustion device in a chemical processing or petrochemical refining operation for combustion thereof,
wherein the oxidizing agent is obtained from an oxygen enrichment device that receives a feed of compressed ambient air from a compressor, and the Flexicoking thermal cracking process receives a feed of compressed air from the compressor.

31. The method according to claim 30, wherein introducing an oxidizing agent having an enriched oxygen source into the low heating value fuel includes modulating the introduction of the oxidizing oxygen.

32. The method according to claim 31, wherein the modulation is based upon at least one of the heating value of the fuel and the load on the turbine.

33. A system for producing work or electricity comprising:
(a) a Flexicoking unit that converts heavy crude oil ground fractions from a distillation process into lighter, gasoline and distillate boiling-range components and a gas byproduct stream;
(b) supply of a low heating value fuel obtained, at least in part, from the gas byproduct stream of the Flexicoking unit;
(c) a supply of an oxidizing agent having an enriched oxygen source; and
(d) a combustion device of a chemical processing or petrochemical refining operation to receive at least a portion of the supply of the low heating value fuel and at least a portion of the supply of oxidizing agent.

34. The system of claim 33, further comprising a compressor to provide a source of compressed ambient air for introduction to the Flexicoking thermal cracking process to provide supplemental air.

35. The system of claim 33, further comprising a compressor to provide compressed air for introduction to an oxygen enrichment device to provide the enriched oxygen source.

36. A system for producing work or electricity comprising:
(a) a Flexicoking unit that converts heavy crude oil ground fractions from a distillation process into lighter, gasoline and distillate boiling-range components and a gas byproduct stream;
(b) supply of a low heating value fuel obtained, at least in part, from the gas byproduct stream of the Flexicoking unit;
(c) an oxygen enrichment device to provide supply of an oxidizing agent having an enriched oxygen source;
(d) a compressor to provide the oxygen enrichment device and the Flexicoking unit with a feed of compressed air; and
(e) a combustion device of a chemical processing or petrochemical refining operation to receive at least a portion of the supply of the low heating value fuel and at least a portion of the supply of oxidizing agent.
